(19) United States
(12) Patent Application Publication
(10) Pub. No.: US 2010/0296759 A1
(43) Pub. Date: Nov. 25, 2010

(54) ENCODER ELEMENT FOR DISPLAYING AN ADJUSTMENT OR MOVEMENT OF A BEARING CONSTITUENT

(75) Inventors: Darius Dlugai, Schweinfurt (DE); Jens Heim, Bergrheinfeld (DE); Ralf Hund, Ruppertshofen (DE); Christian Mock, Schweinfurt (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/738,753

(22) PCT Filed: Oct. 16, 2008
(86) PCT No.: PCT/DE08/01691

§ 371 Date: Jul. 12, 2010

(30) Foreign Application Priority Data
Oct. 20, 2007 (DE) 10 2007 050 256.9

(51) Int. Cl. F16C 41/00; H01F 1/00

(52) U.S. Cl. 384/448; 335/296

(57) ABSTRACT

An economically producible and compact encoder element for displaying an adjustment and/or movement of a bearing constituent. The encoder element has a carrier and a magnetic or magnetizable encoder layer applied flatly to the carrier. The encoder layer is formed from a matrix material which is liquid in its raw state and a magnetic powder added thereto, and is applied directly to a carrier surface in the liquid raw state by a coating method.

### FIELD OF THE INVENTION

The invention concerns an encoder element for displaying an adjustment and/or movement of a bearing constituent, in particular a constituent of a wheel bearing. The invention also relates to a bearing with such an encoder element.

An encoder generally serves for recording one or more measured variables that are characteristic of the adjustment and/or movement of a movable bearing constituent. Understood here as measured variables that are characteristic of the adjustment of the bearing constituent are, in particular, an angle of rotation, a tilting with respect to a bearing axis or a distance from a predetermined reference point. Measured variables that are characteristic of the movement of the bearing constituent particularly comprise the rotational speed, the direction of movement or variables that characterize the vibration of the bearing constituent. Encoders are also used for recording measured variables derived from the adjustment information and/or movement information as such, particularly acting forces and torques or the temperature of the bearing.

### BACKGROUND OF THE INVENTION

The use of magnetic encoders for wheel bearings is known in automotive engineering. Corresponding encoders are known, for example, in WO 2006/026950 A2, DE 20 2006 017 414 U1 and EP 1 722 238 A2.

The known encoders respectively comprise an encoder element which is formed by a carrier and a magnetic layer applied thereto. In this case, the carrier is an annular sheet-metal part. The magnetic layer consists either of a thermoplastic or an elastomer, this material in each case being filled with a magnetic powder. In the case of an elastomer layer, it is usually vulcanized on the carrier. In the case of a thermoplastic layer, it is usually adhesively attached to the carrier.

For use as an encoder, the layer of the encoder element filled with the magnetic powder is provided with a magnetic coding in a downstream production step.

The production of such encoder elements is comparatively complex. Moreover, the magnetic layers of these encoder elements must be made comparatively thick for dependable processing under the conditions of the process. This means that such an encoder element requires a comparatively large installation space.

Also known, from DE 10 2004 063 462 B3, is a method for producing a scale carrier for a magnetic length or angle measurement. In the case of this method, a groove formed in a machine part is filled with a magnetic powder paste. After hardening of the magnetic powder paste, the surface formed over the groove is smoothed flush with the adjacent surface of the machine part, in particular by machining processes. However, the production of such a scale carrier is likewise comparatively complex.

### SUMMARY OF THE INVENTION

The invention is based on the object of providing an easily producible and space-saving encoder element for displaying an adjustment and/or movement of a bearing constituent. The invention is also based on the object of providing a bearing with such an encoder element.

This object is achieved according to the invention with respect to the encoder element by the features of claim 1. Accordingly, the encoder element includes a carrier with a magnetic or magnetizable encoder layer applied flatly to it. The encoder layer is formed here from a matrix material which is liquid in the raw state, with added magnetic powder, and is applied directly to a carrier surface from the liquid raw state by a coating process.

Understood here as the coating process—in particular in differentiation from casting processes, adhesive bonding processes and vulcanizing processes, which require separate prefabrication of the encoder layer or the use of a mold—is a procedure in which the liquid coating material is freely applied directly to the carrier surface. Particularly suitable coating techniques comprise an operation involving application by brushing, spraying, dipping or pressing and a subsequent hardening process.

Such a coating process can, on the one hand, be easily carried out from technical aspects of production. On the other hand, an encoder layer with a particularly small thickness can be realized in this way. In a preferred configuration, the thickness of the encoder layer produced according to the invention is less than 0.8 mm, in particular between 0.3 mm and 0.7 mm.

Used with preference as the matrix material for the encoder layer is a lacquer. However, a different coating compound (paint), an adhesive or a resin may also be used as the matrix material, provided that this material in the hardened state enters into an adhesive bond with the carrier and can be applied by means of the coating process. The matrix material may also be composed of the mixture of more than one substance of the aforementioned type.

The magnetic powder is preferably a ferrite, a rare-earth metal or a mixture of such magnetizable constituents. In an advantageous configuration, at least 50% by volume of magnetic powder, measured in the liquid raw state, is added to the matrix material.

In a preferred configuration of the invention, the encoder element is developed into the finished encoder by a magnetization being impressed on the encoder layer.

In an expedient variant of the invention, the encoder layer carries an annular magnetization track with a polarity that alternates periodically in the circumferential direction, i.e. a magnetization track of which the magnetization—particularly the axially oriented magnetization—periodically changes signs in the circumferential direction. Optionally, a number of magnetization tracks arranged concentrically in relation to one another may be impressed into the encoder layer. These magnetization tracks differ in particular in that the polarity of every two magnetization tracks varies in a different way in dependence on the angle of rotation.

Such an encoder serves, in particular, for displaying a rotational adjustment, rotational speed and/or direction of rotation, etc. of the associated bearing constituent.

In an alternative configuration, a magnetization that is homogeneous in the circumferential direction is impressed in the encoder layer. The encoder implemented in such a way makes it possible, in particular, to display a tilted position of the associated bearing constituent with respect to a bearing axis.

Both coding variants may also be implemented on one and the same encoder layer, for example in that two concentric magnetization tracks, one with polarity alternating in the circumferential direction and one with homogeneous magnetization, are provided.

To protect the encoder layer better against environmental influences, in an advantageous configuration of the invention the encoder layer is coated by a non-magnetic protective layer on the side facing away from the carrier. This protective layer preferably consists of a lacquer, a thermoplastic or an elastomer, in the latter case the protective layer expediently being vulcanized on the carrier and the encoder layer. In an embodiment that is particularly insensitive to aging effects and environmental influences, this protective layer consists of the same matrix material that also forms the basic substance of the encoder layer, but, in contrast to the encoder layer, no magnetic powder is added to the protective layer. The protective layer preferably has a smaller thickness in comparison with the encoder layer. In particular, in the case of a lacquer coating, the protective layer is preferably only a few micrometers thick.

In an advantageous variant of the invention, the carrier is formed by an angled plate which is fastened or is fastenable to the bearing constituent. In another advantageous embodiment, the encoder layer is applied directly to an inner bearing race or an outer bearing race, so that this inner or outer bearing race serves as the carrier.

In the case of a bearing in which the inner bearing race or outer bearing race has two running surfaces for rolling elements at a distance axially from one another with respect to a bearing axis, in an expedient configuration of the invention the encoder layer is arranged between these two running surfaces, and consequently in the interior of the bearing. As a result, the encoding layer is protected particularly effectively from environmental influences, in particular dirt and water.

In a further variant of the invention, the encoder layer is applied directly to a hub or a bearing flange, so that in this case the hub or the bearing flange serves as the carrier for the encoder layer.

In a further variant of the invention, the carrier of the encoder layer is formed by a rolling element cage or by a rolling element. The last-mentioned configuration is used with preference in the case of a bearing with roller-shaped rolling elements. The encoder layer is in this case applied in particular to one of the end faces of the rolling element—which is largely free from loading during the operation of the bearing. The application of the encoder layer to one or more rolling elements is advantageous in particular for testing and inspection purposes, in order to technically record the circulation and/or rotation of the rolling elements during the operation of the bearing to be tested.

In a further variant of the invention, the carrier carrying the encoder layer is part of a bearing seal. In particular, here the carrier forms a sealing surface against which a sealing lip of the bearing seal lies.

In all the aforementioned variants of the invention, the carrier surface carrying the encoder layer is preferably aligned at least partially axially (i.e. perpendicularly to the bearing axis), radially (substantially concentrically to the bearing axis) or obliquely to the bearing axis in the intended installation position of the respective carrier.

The above object is achieved according to the invention with respect to the bearing by the features of claim 21. According to this claim, the bearing comprises an encoder element of the type described above.

In order to record the orientation of a movable bearing constituent with the aid of the encoder element, the bearing expediently additionally comprises a magnetic sensor. The magnetic sensor is in this case associated with the encoder element provided with a magnetization in such a way that it records the magnetic field generated by the encoder element during the operation of the bearing. The magnetic sensor derives from this a measurement signal that is characteristic of the adjustment and/or movement of the bearing constituent.

The advantages that the invention involves are, in particular, that, as a result of the particularly flat and consequently space-saving encoder layer, the application of the same can take place at virtually any location of the bearing. Depending on the requirements that a specific bearing has to meet, the encoder layer may therefore be applied at the location that is optimal for this bearing. The production of the encoder layer is also particularly uncomplex, and consequently cost-effective.

All the variants described above for applying the encoder layer to various bearing constituents may also be used in combination with one another. In particular, a number of encoder layers may be provided on a bearing at different bearing constituents.

### BRIEF DESCRIPTION OF THE DRAWINGS

Exemplary embodiments of the invention are explained in more detail below with reference to a drawing, in which:

FIG. 1 shows a wheel bearing, represented as a detail, in a cross section along a bearing axis, with an inner race and an encoder element connected in one piece thereto;

FIG. 2 shows a detail II of the bearing according to FIG. 1 in an enlarged representation;

FIG. 3 shows an alternative embodiment of the bearing in a representation according to FIG. 1;

FIG. 4 shows a detail IV of the bearing according to FIG. 3 in an enlarged representation;

FIG. 5 shows a further embodiment of the bearing in a representation according to FIG. 2;

FIGS. 6 and 7 show two further configurational variants of the bearing in a representation according to FIG. 1, represented as a detail, in the case of which the encoder element is respectively integrated in a hub or a bearing flange, respectively;

FIGS. 8 and 9 show two further configurational variants of the bearing in a representation according to FIG. 1, represented as a detail, in the case of which the encoder element is a constituent of an outer race which is rotatable with respect to an inner race;

FIG. 10 shows a further configurational variant of the bearing in a representation according to FIG. 2, represented as a detail, in the case of which the encoder element has a carrier comprising an angled plate, the carrier being integrated in a bearing seal;

FIGS. 11 to 14 show various configurational variants, each in cross section, of the bearing seal with an integrated encoder element;

FIGS. 15 to 20 show various embodiments, each in cross section, of the encoder element provided with an angled plate, configured differently in each case, as the carrier;

FIG. 21 shows a further embodiment of the encoder element in a representation according to FIG. 15, with an impressed magnetization;

FIGS. 22 to 24 show the encoder element according to FIG. 17 in a perspective representation, with multipole magnetization impressed in a different way in each case;

FIG. 25 shows a rolling bearing in a perspective representation, with roller-shaped rolling elements, at least one of which contains the encoder element,

FIG. 26 shows the rolling bearing according to FIG. 25 in a cross section; and

FIGS. 27 to 30 show various configurations of rolling element cages in which the encoder element is in each case integrated, each in a perspective, partly sectioned representation.

### DETAILED DESCRIPTION OF THE DRAWINGS

Parts and variables that correspond to one another are provided with the same designations in all the figures.

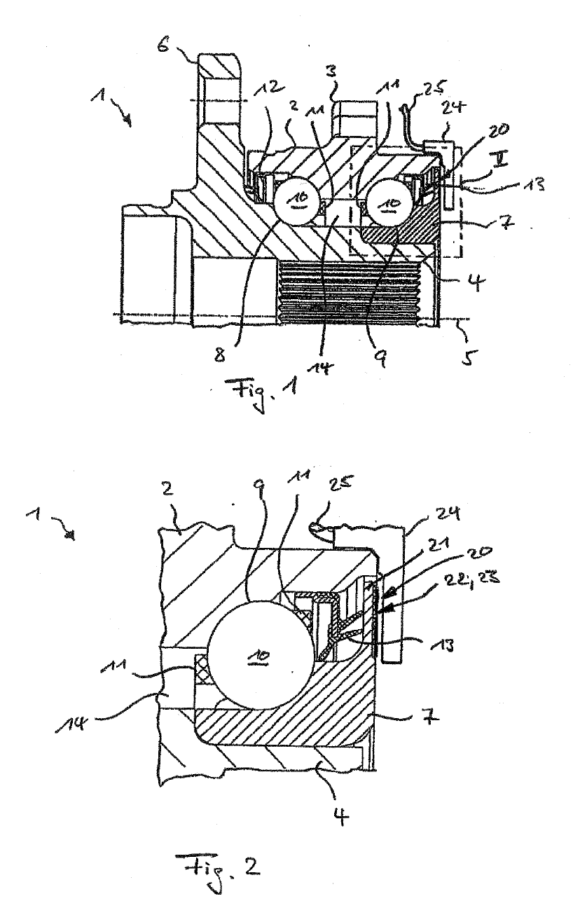

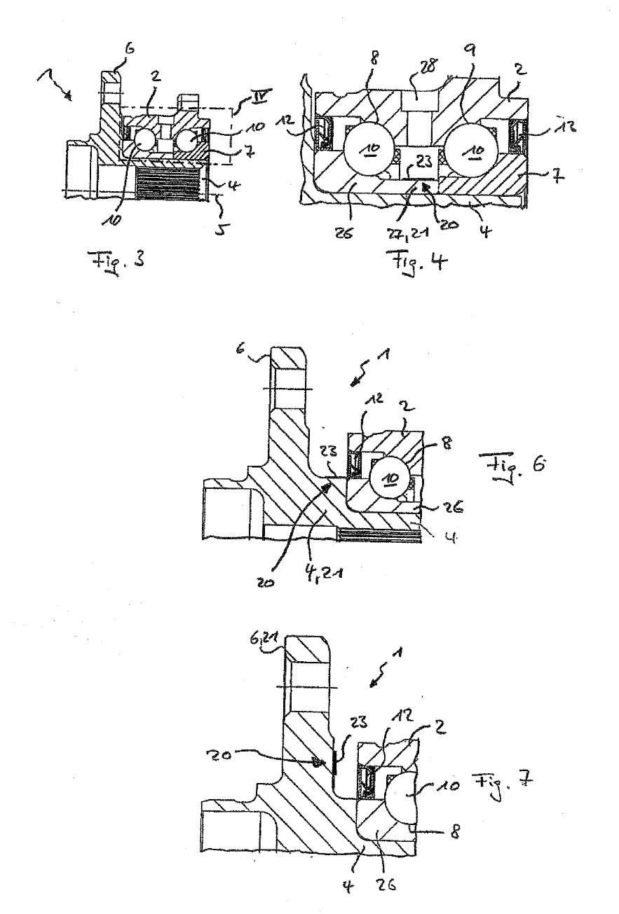

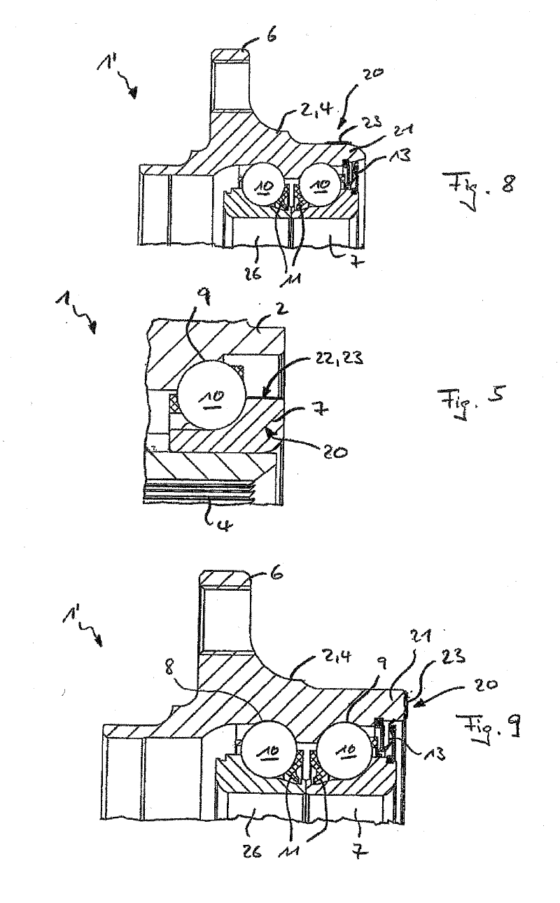

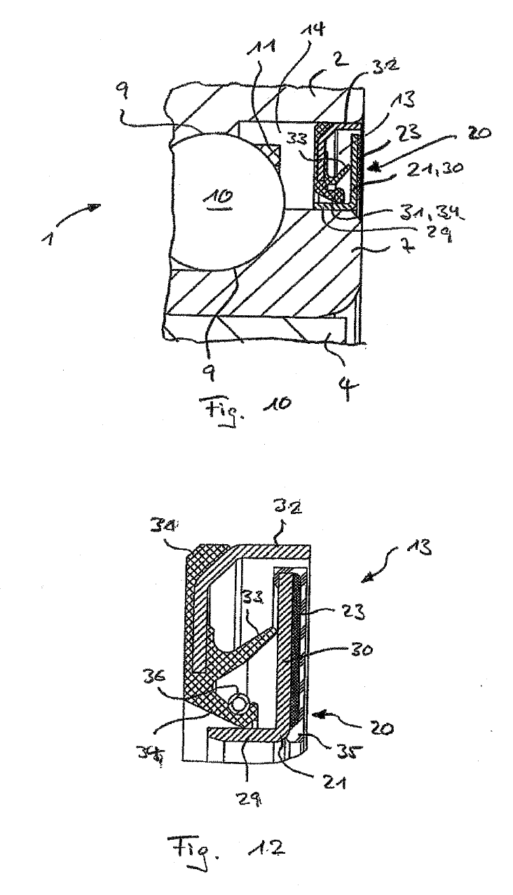

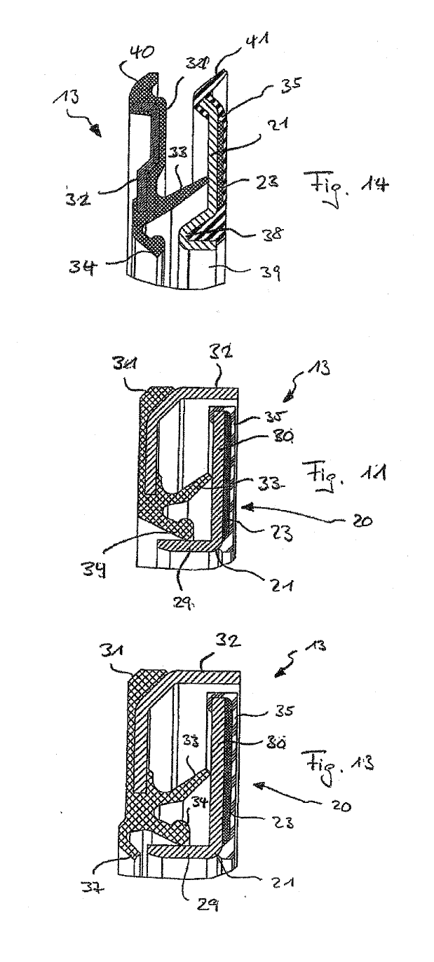

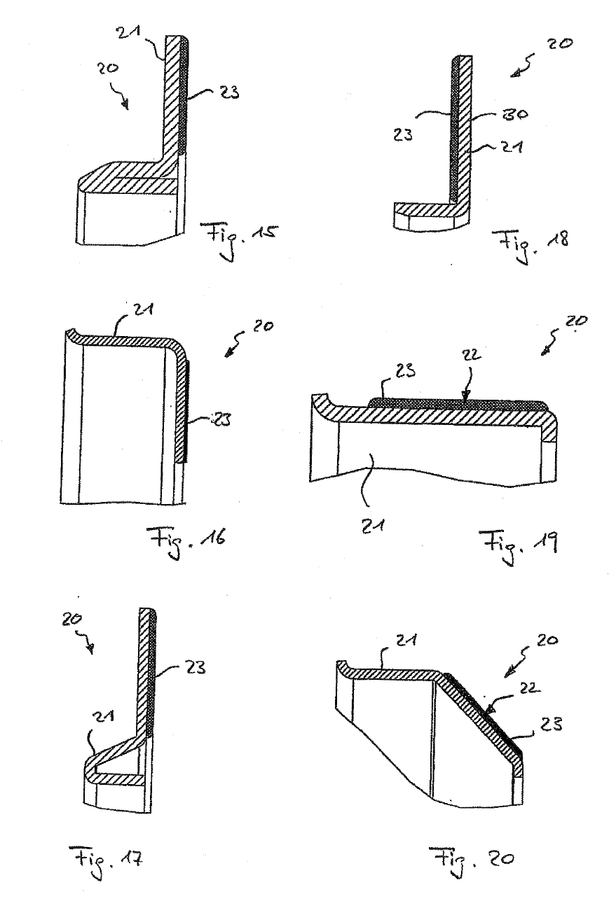

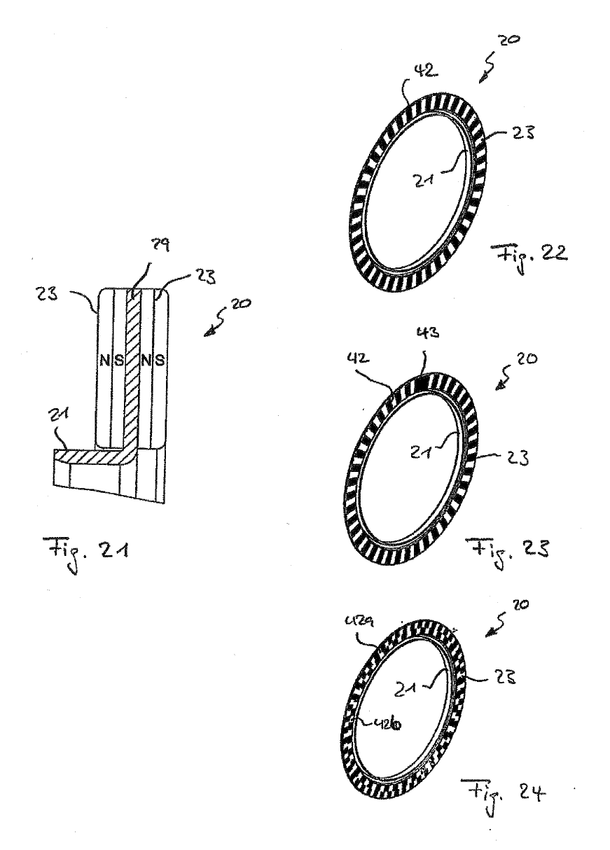

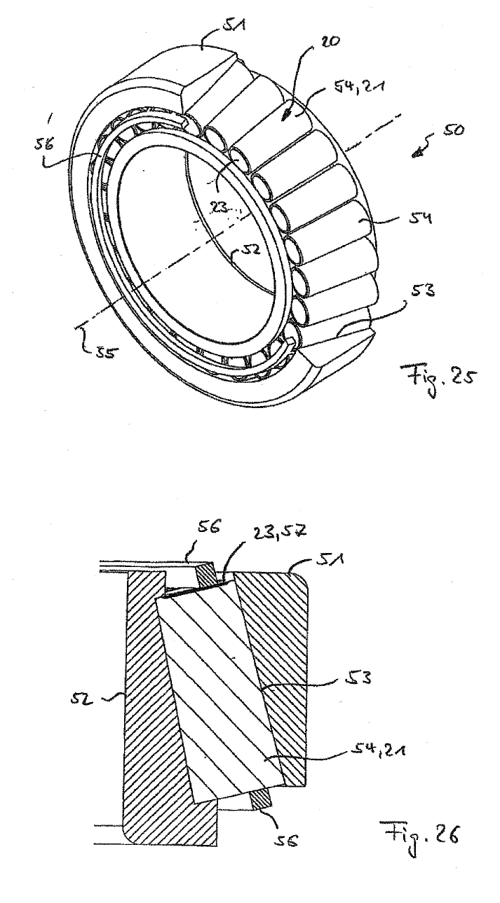

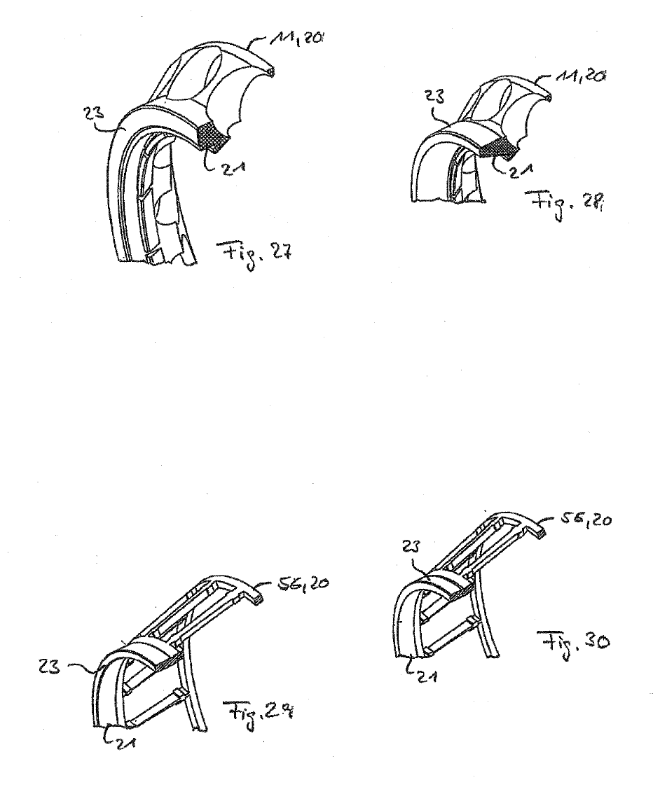

FIGS. 1 and 2 show a (wheel) bearing 1 for the rotatable suspension of a motor vehicle wheel on a motor vehicle body. The bearing 1 comprises an outer race 2, which can be fixed to the wheel suspension of the vehicle body in a rotationally fixed manner by means of a body flange 3. The bearing 1 further comprises a hub 4, which is held rotatably about a bearing axis 5 within the outer race 2. At one end face, the hub 4 merges in one piece with a radial flange 6, which serves for the suspension of a vehicle wheel. At the end face of the hub 4 opposite from the radial flange 6, an inner race 7 is connected to said hub in a rotationally fixed manner.

Formed between the outer race 2 and the hub 4 with the inner race 7 fastened on it are two axially spaced-apart raceways 8 and 9, which concentrically surround the bearing axis 5 in an annular form and in which ball-shaped rolling elements 10 circulate. The rolling elements 10 circulating in each of the raceways 8 and 9 are rotatably enclosed in an annular (rolling element) cage 11 in each case. Outside the raceways 8 and 9, a seal 12 or 13 is respectively provided at both end faces of the bearing 1, between the outer race 2 and the hub 4 or between the outer race 2 and the inner race 7, respectively. These seals 12, 13 serve the purpose of sealing the bearing gap 14 formed between the outer race 2 and the hub 4 and between the outer race 2 and the inner race 7 from penetrating dirt and penetrating moisture. The seals 12 and 13 also prevent lubricating grease from escaping from the bearing gap 14.

The bearing 1 further comprises an encoder element 20, represented in more detail in FIG. 2. This encoder element 20 comprises a carrier 21, which protrudes into the bearing gap 14 outside the seal 13 and is formed by a collar-like annular attachment formed in one piece with the inner race 7. The outer side of the carrier 21, facing away from the raceway 9, forms a carrier surface 22, to which an axially aligned encoder layer 23 is applied. The encoder layer 23 consists of a matrix material in the form of a lacquer, to which a magnetic powder in the form of ferrites is added. The encoder layer 23 has a thickness of about 0.4 mm and bears a multipolar magnetization, impressed after the hardening of the lacquer layer.

Arranged outside the encoder element 20 is a magnetic sensor 24 in the form of a Hall sensor or a magnetoresistive sensor. Here, the magnetic sensor 24 is fastened to the outer race 2 in a rotationally fixed manner, in particular is adhesively bonded to it. During the operation of the bearing 1, the magnetic sensor 24 measures the magnetic field generated by the encoder element 20 and fluctuating during rotation of the hub 4 at the location of the magnetic sensor 24. The magnetic sensor 24 thereby emits by way of a feed line 25 a measurement signal correlating with the intensity of the measured magnetic field, from which the rotational speed and/or the rotationally angular orientation of the hub 4 is determined by an evaluation unit that is not represented.

The embodiment of the bearing 1 represented in FIGS. 3 and 4 differs from the embodiment described above in that here the raceway 8 is not formed directly between the outer race 2 and the hub 4. Rather, in this embodiment, an additional inner race 26 is pushed onto the hub 4 and forms the radially inner part of the raceway 8. This inner race 26 is extended in the axial direction into the bearing interspace 27 formed between the raceways 8 and 9.

In the case of the configuration according to FIGS. 3 and 4, this extension of the inner race 26 serves as a carrier 21 for the encoder layer 23, which is applied here to the outer side of the inner race 26. The encoder element 20 is therefore formed by the encoder layer 23 and the inner race 26 acting as the carrier 21, with the encoder layer 23 being aligned radially with respect to the bearing axis 5.

Opposite the encoder layer 23, a radial bore 28 is provided in the outer race 2 for receiving a magnetic sensor (not represented here).

In the case of the variant of the bearing 1 that is represented in FIG. 5, by contrast with FIG. 2, there is no annular continuation of the inner race 7 acting there as the carrier 21. Instead, here the carrier surface 22 carrying the encoder layer 23 is formed by a cylindrical surface portion of the inner race 7 which adjoins the raceway 9 axially on the outside. The encoder layer 23 is aligned here—in the same way as the carrier surface 22—radially with respect to the bearing axis 5.

The variants of the bearing 1 that are represented in FIGS. 6 and 7 are substantially the same as the embodiment described in connection with FIGS. 3 and 4. According to FIG. 6, however, as a difference from this, the encoder layer 23 outside the bearing seal 12 is applied directly to the outer circumference of the hub 4. The encoder element 20 is therefore formed here by the encoder layer 23 and the hub acting as the carrier 21. The encoder layer 23 is in this case once again radially arranged. In the embodiment according to FIG. 7, on the other hand, the encoder layer 23 is applied to the end face of the radial flange 6 that is facing the seal 12, so that the encoder element 20 is formed by the encoder layer 23 and the radial flange 6 acting as the carrier 21. In this configuration, the encoder layer 23 is once again axially aligned.

Represented in FIGS. 8 and 9 is a further (wheel) bearing 1′, in which—in contrast to the embodiments described above—the outer race 2 forms the rotating hub 4 and is connected in one piece to the radial flange 6. On the other hand, here, as intended, the two inner races 7 and 26, as in the case of the exemplary embodiments above, together with the outer race 2 form the raceways 9 and 8, are connectable in a rotationally fixed manner to the wheel suspension of the vehicle body.

In the configuration according to FIG. 8, the encoder layer 23 is applied to the outer circumference of the outer race 2, so that the encoder element 20 is formed here by the encoder layer 23 and the outer race 2 acting as the carrier 21 and the encoder layer 23 is radially aligned.

Deveating from this, according to FIG. 9, the encoder layer 23 is applied to an annular region on the end face of the outer race 2, so that the encoder layer 23 is axially aligned here with respect to the bearing axis 5.

FIG. 10 shows once again an embodiment of the bearing 1 corresponding substantially to FIGS. 1 and 2, with a fixed outer race 2 and a hub 4 mounted rotatably therein, with an inner race 7 fixed with respect to said hub. According to FIG. 10—deveating from FIGS. 1 and 2—a separate annular angled plate with an approximately L-shaped cross section is provided as the carrier 21. An axial leg 29 of this L-shaped carrier 21 is pushed onto the outer circumference of the inner race 7 with a press fit, so that the carrier is fixed on the inner race 7 in a rotationally fixed manner. A radial leg 30 closing off the end of the bearing gap 14 is coated axially on the outside with the encoder layer 23. The encoder layer 23 is thereby axially aligned.

In the case of the exemplary embodiment according to FIG. 10, the encoder element 20 is part of the seal 13, which further comprises a sealing lip 31 and a carrier 32. The sealing lip 31 consists of an elastomer material and is vulcanized on the carrier 32 formed by an angled plate. This carrier 32 is pushed into the outer race 2 with a press fit, so that the sealing lip 31 is coupled to the outer race 2 in a rotationally fixed manner by means of the carrier 23. The sealing lip 31 comprises an axially acting partial lip 33, which lies in a sealing manner against an inner surface of the radial leg 30 opposite from the encoder layer 23. The sealing lip 31 further comprises a radially acting partial lip 34, which lies in a sealing manner against the axial leg 29.

FIG. 11 shows a further configuration of the seal 13, which corresponds substantially to the embodiment represented in FIG. 10. Deveating from it, however, according to FIG. 11, the encoder layer 23 is additionally coated with a protective layer 35 of lacquer. The protective layer 35 consists in particular of the lacquer that also forms the matrix material of the encoder layer 23. However, no magnetic powder is added to the protective layer 35, so that the protective layer 35 is not magnetic.

The configuration of the seal 13 that is represented in FIG. 12 corresponds substantially to the embodiment described above, but according to FIG. 12, deveating from the last-mentioned configuration, the partial lip 34 is additionally prestressed in the radial direction against the axial leg 29 by a spiral-type expander 36.

The configuration of the seal 13 that is represented in FIG. 13 corresponds once again substantially to the embodiment according to FIG. 11. However, here the sealing lip 31 comprises in addition to the partial lips 33 and 34, a third partial lip 37, which is arranged such that it is retracted in the axial direction behind the axial leg 29 of the carrier 21, and in the intended installation position comes to bear in a sealing manner directly against the outer circumference of the inner race 7.

FIG. 14 shows a further embodiment of the seal 13, which differs from the embodiments described above in particular by a modified shaping for the carriers 21 and 32. Thus, in this embodiment the carrier 21 carries at its radially inner end instead of the axial leg 29 a bead 38, which is concave when seen from the outer side of the bearing, and the radially inner border 39 of which runs in an approximately axial direction. On account of this shaping, the carrier 21 does not overlap in the axial direction with the partial lip 34 of the sealing lip 31. Instead, in this configuration, the sealing lip 31 is configured in such a way that, in the installation position, its partial lip 34 comes to lie in a sealing manner directly against the outer circumference of the inner race 7.

According to FIG. 14, the carrier 32 is formed by a substantially radially aligned sheet-metal ring. Deveating from the embodiments of the seal 13 described above, here the sealing lip 31 protrudes beyond the radially outer border of the carrier 32 with a holding bead 40, which in the intended installation position lies under prestress in a corresponding groove in the outer race 2.

According to FIG. 14, provided as the protective layer 35 is an elastomer layer, which is vulcanized on the carrier 21 with the encoder layer 23 applied thereto. Deveating from the embodiments described above—this elastomeric protective layer 35 is shaped at its radially outer border, protruding beyond the carrier 21, into a further sealing lip 41, which as intended in the installation position of the seal 13 comes to lie in a sealing manner against the inner circumference of the outer race 2.

FIGS. 15 to 17 show further embodiments of the encoder element 20, in which the carrier 21, always produced here from an annular sheet-metal part, is formed in a different way in each case—which can be seen in each case directly from the drawing. In the case of these exemplary embodiments, the encoder layer 23 is always arranged in such a way that in the intended installation position it is axially aligned and facing the outer side of the bearing.

By contrast with this, FIG. 18 shows an exemplary embodiment of the encoder element 20 in which the encoder layer 23 is applied to the inside of the radial leg 29 of a carrier 21, here once again bent in an angular form.

On the other hand, FIGS. 19 and 20 show exemplary embodiments of the encoder element 20 with a carrier 21 formed in each case from an annular sheet-metal part, in the case of which the encoder layer 23 is respectively applied to the outside of a radially or obliquely aligned carrier surface 22.

FIGS. 21 to 24 show various examples of a magnetic coding of the encoder element 20.

According to FIG. 21, the encoder element 20 comprises a carrier 21 of an angularly bent sheet-metal part. Here, however, the radial leg 29 of this carrier 21 is coated with an encoder layer 23 on both sides. According to FIG. 21, a magnetization which is of the same polarity in the axial direction and is homogeneous over the entire circumference of the annular encoder element 20, is impressed on these encoder layers 23. In the representation, the magnetization of the encoder layers 23 is indicated by zones which are marked “N” for the magnetic North pole and “S” for the magnetic South pole. The homogeneous magnetization of the encoder element 20 makes it possible in particular in the case of the bearing 1 represented in FIG. 10 to record a tilting of the hub 4 with respect to the bearing axis 5.

FIG. 22 shows an encoder element 20 which corresponds substantially to the embodiment represented in FIG. 17. Here, a magnetization is impressed on the encoder layer 23, the polarity of which—measured in the axial direction—periodically fluctuates uniformly over the circumference of the encoder element 20. The location—dependent polarity of the encoder layer 23 is visually indicated here in the representation by black and white zones. If the encoder layer 23 is followed in the circumferential direction of the encoder element 20, a characteristically fluctuating magnetization pattern is consequently obtained (corresponding to a sequence of black and white zones in the representation) and is also referred to hereafter as the magnetization track 42.

While the encoder element 20 shown in FIG. 22 has a regularly fluctuating magnetization track 42 for displaying the rotational speed, this regularity is interrupted in the case of the embodiment of the encoder element 20 shown in FIG. 23, in that a polarity region that has an increased extent of the angle at circumference in comparison with the other polarity regions is provided there within the magnetization track 42. This marked polarity region serves as a zero adjustment marking 43 and makes it possible to determine the absolute rotational speed angle of the associated bearing constituent, in particular therefore of the inner race 7 and the hub 4 connected to it.

In the embodiment according to FIG. 24, two concentric magnetization tracks 42a, 42b are impressed on the encoder layer 23, the polarity of which fluctuates in different ways on the basis of the rotational adjustment of the encoder element 20. This embodiment of the encoder element 20 makes it possible in addition to the absolute and relative determination of the angle of rotation also to determine the direction of rotation of the associated bearing constituent.

FIGS. 25 and 26 show a (rolling) bearing 50 as a further embodiment of the invention. The bearing 50 comprises an outer race 51 and an inner race 52. Formed between the outer race 51 and the inner race 52 is a raceway 53, in which roller-shaped rolling elements 54 circulate about a bearing axis 55. These rolling elements 54 are rotatably enclosed by a rolling element cage 56. In the case of the exemplary embodiment represented in FIGS. 25 and 26, one or more rolling elements 54 serve as carrier 21, in that the encoder layer 23 is applied to an end face 57 of this rolling element 54 or these rolling elements 54.

If this encoder layer 23 is homogeneously magnetized, the circumferential speed of the rolling elements 54 formed as the encoder element 20, i.e. the movement of the center of gravity of the rolling elements 54, can be recorded by means of a magnetic sensor fastened to the stationary bearing constituent. If a magnetization of varying polarity in the circumferential direction of the rolling element 54 is impressed on the encoder layer 23, the rolling speed of the rolling elements 54 can also be determined. Knowledge of these variables is of interest in particular for testing and inspection purposes as part of bearing development.

Finally, FIGS. 27 to 30 show embodiments of the invention in which a rolling element cage 11 or 56 is formed integrally as the encoder element 20, in that part of this cage 11 or 56 serves as the carrier 21 for the encoder layer 23. In other words, in these embodiments, the encoder layer 23 is applied directly to the cage 11 or 56. According to FIGS. 27 and 29, the encoder layer 23 is applied here to an end face of the cage 11 or 56, so that the encoder layer 23 is axially aligned with respect to the bearing axis 5 or 55, respectively. According to FIGS. 28 and 30, the encoder layer 23 is applied to the outer circumference of the respective cage 11 or 56, so that the encoder layer 23 is aligned here radially with respect to the bearing axis 5 or 55, respectively.

In the case of all the exemplary embodiments described, the encoder layer 23 is sprayed directly onto the component respectively serving as the carrier 21. Serving here as the starting material is a liquid lacquer suitable for application to a metal surface, to which preferably about 60% by volume of a magnetic powder of ferrites is added. After the application and hardening of the lacquer with added magnetic powder, the encoder element 20 itself is complete. In a following production step, the possibly provided protective layer 35 is then optionally applied and/or a desired magnetization is impressed.

List of Designations

| | |
|---|---|
| 1, 1′ | (Wheel) bearing |
| 2 | Outer race |
| 3 | Body flange |
| 4 | Hub |
| 5 | Bearing axis |
| 6 | Radial flange |
| 7 | Inner race |
| 8, 9 | Running surfaces |
| 10 | Rolling element |
| 11 | (Rolling element) cage |
| 12, 13 | Seal |
| 14 | Bearing gap |
| 20 | Encoder element |
| 21 | Carrier |
| 22 | Carrier surface |
| 23 | Encoder layer |
| 24 | Magnetic sensor |
| 25 | Measurement signal |
| 26 | Inner bearing race |
| 27 | Bearing interspace |
| 28 | Bore |
| 29 | Axial leg |
| 30 | Radial leg |
| 31 | Sealing lip |
| 32 | Carrier |
| 33 | Partial lip |
| 34 | Partial lip |
| 35 | Protective layer |
| 36 | Spiral-type expander |
| 37 | Partial lip |
| 38 | Bead |
| 39 | Border |
| 40 | Holding bead |
| 41 | Sealing lip |
| 42, 42a, 42b | Magnetization track |
| 50 | (Rolling) bearing |
| 51 | Outer race |
| 52 | Inner race |
| 53 | Raceway |
| 54 | Rolling element |
| 55 | Bearing axis |
| 56 | (Rolling element) cage |
| 57 | End face |

1. An encoder element for displaying an adjustment and/or movement of a bearing constituent, comprising:
a carrier; and
a magnetic or magnetizable encoder layer applied flatly to it the carrier.
the encoder layer being formed from a matrix material which is liquid in a raw state, with added magnetic powder, and the encoder layer being applied directly to a carrier surface from the liquid raw state by a coating process.

2. The encoder element of claim 1, wherein the encoder layer is applied to the carrier surface by brushing, spraying, dipping or pressing with subsequent hardening.

3. The encoder element of claim 1, wherein the encoder layer has in a hardened state a thickness of less than 0.8 mm, preferably between 0.3 mm and 0.7 mm.

4. The encoder element in claim 1, wherein the matrix material is formed by a lacquer, a coating compound, an adhesive or a resin.

5. The encoder element of claim 1, wherein the magnetic powder contains a ferrite and/or a rare-earth metal.

6. The encoder element claim 1, wherein at least 50% by volume of the magnetic powder is added to the matrix material.

7. The encoder element of claim 1, wherein the encoder layer has a magnetization track with polarity alternating periodically in a circumferential direction.

8. The encoder element of claim 1, wherein the encoder layer has a magnetization that is homogeneous in a circumferential direction.

9. The encoder element of claim 1, wherein the encoder layer being is coated with a non-magnetic protective layer of a lacquer, a thermoplastic or an elastomer.

10. The encoder element of claim 1, wherein the carrier is formed by an angled plate which is fastenable or is fastened to the bearing constituent.

11. The encoder element of claim 1, wherein the bearing constituent is an inner bearing race or outer an bearing race serving directly as the carrier for the encoder layer.

12. The encoder element of claim 11, wherein the inner bearing race or the outer bearing race have two running surfaces for rolling elements at a distance axially from one another with respect to a bearing axis, and the encoder layer is arranged between the two running surfaces.

13. The encoder element of claim 1, wherein the bearing constituent is a hub or a radial flange, which serves directly as the carrier for the encoder layer.

14. The encoder element of claim 1, wherein the carrier is formed by a rolling element cage.

15. The encoder element of claim 1, wherein the bearing constituent is a roller-shaped rolling element, which serves directly as the carrier for the encoder layer.

16. The encoder element of claim 15, wherein the encoder layer is applied to an end face of the rolling element.

17. The encoder element of claim 1, wherein the carrier is part of a bearing seal, in particular forming a sealing surface intended for lying against a sealing lip.

18. The encoder element of claim 1, wherein the carrier surface carrying carries the encoder layer which is aligned at least partially axially with respect to a bearing axis an installation position of the carrier.

19. The encoder element claim 1, wherein the carrier surface carries the encoder layer being which is aligned at least partially radially with respect to a bearing axis in the an installation position of the carrier.

20. The encoder element of claim 1, wherein the carrier surface carries the encoder layer which is aligned at least partially obliquely to a bearing axis in an installation position of the carrier.

21. A bearing, comprising:
the encoder element as claimed in claim 1.

22. The bearing of claim 21, with a magnetic sensor for measuring a magnetic field generated by the encoder element and, for generating from the measured magnetic field, a measurement signal that is characteristic of an adjustment and/or movement of a bearing constituent.
